(19) United States
(12) Patent Application Publication
(10) Pub. No.: US 2002/0149002 A1
(43) Pub. Date: Oct. 17, 2002

(54) Anionically stabilized aqueous dispersions of nanoparticle zinc oxide, a process for their production, as well as their use

(76) Inventors: Hermann Jens Womelsdorf, Leverkusen (DE); Gerd Passing, Koln (DE); Volker Wege, Neuss-Rosellen (DE); Joachim Wagner, Koln (DE); Bernd Hynek, Pulheim (DE); Lothar Reif, Dormagen (DE)

Correspondence Address: BAYER CORPORATION, PATENT DEPARTMENT, 100 BAYER ROAD, PITTSBURGH, PA, 15205, US

(21) Appl. No.: 10/116,220

(22) Filed: Apr. 4, 2002

(30) Foreign Application Priority Data
Apr. 12, 2001 (DE) 10118309.7

(51) Int. Cl. B01F 3/00

(52) U.S. Cl. 252/363.5

(57) ABSTRACT

The invention relates to anionically stabilized aqueous dispersions of nanoparticle zinc oxide having a mean primary particle diameter of ≦30 nm and a mean agglomerate size of ≦100 nm, wherein the surface of the zinc oxide particles at pH values of ≧7 has a negative charge and the content of nanoparticle zinc oxide in the dispersion is 0.01 to 30 wt. %, a process for their production, as well as their use as vulcanization activators for the vulcanization of latex molded articles.

### FIELD OF THE INVENTION

The present invention relates to anionically stabilized aqueous dispersions of nanoparticle zinc oxide, a process for their production, as well as their use.

### BACKGROUND OF THE INVENTION

Nanoparticle systems open the way to applications that are not feasible with larger particles, such as, for example, UV protection using nanoparticle inorganic UV absorbers in transparent applications, and also enable significant improvements in effectiveness to be achieved in application fields in which attention is concentrated on surfaces that are as large as possible combined with a homogeneous distribution of the active species.

In order to be able to exploit nanoparticle systems, it is accordingly, particularly important to preserve the nanoparticle state of the system up to the point of application. For this purpose, it is often necessary to redisperse the particles obtained from the production in application-specific preparations. In this connection, a particular precondition is the need to produce application-specific nanoparticle and nano-dispersed preparations that are sedimentation-stable over long periods and large temperature ranges, and also are insensitive to other dispersion constituents, such as, for example, electrolytes or charged particles.

Thus, for example, nanoparticle zinc oxide cannot be directly dispersed in a stable manner in water on account of its amphoteric nature and the position of the isoelectric point (pH ca. 9.5). There is only a slight stability, in particular, towards added electrolytes and ionic dispersion constituents. Aqueous dispersions of zinc oxide cannot be stabilized simply by displacing the pH to values >9.5, since a destabilization of the dispersion occurs if the isoelectric point is exceeded.

Another possibility of stabilization is to displace the isoelectric point to lower pH values. This may be effected in principle by using polyelectrolytes. Such a procedure is described in WO-A 95/24359, in which the sodium salt of a polyacrylic acid is used as grinding additive in the grinding of zinc oxide. For aqueous dispersions of zinc oxide nanoparticles produced according to DE 199 07 704 A1, no stabilizing effect but instead a destabilizing effect was found on adding polyacrylic acid salts.

Recent stabilization methods have, moreover, been described that utilize the known good water dispersibility of silicate surfaces, by coating zinc oxide particles with a dense, amorphous SiO₂ layer. For example, U.S. Pat. No. 5,914,101 describes aqueous dispersions of particulate zinc oxide and a stabilizer in which the zinc oxide particles are coated in a technically complicated process with a dense amorphous layer of SiO₂. A disadvantage of this process is that the coating leads to a marked loss of chemical activity, with the result that the chemical properties of the zinc oxide, such as are needed, for example, for catalytic purposes, are lost.

### SUMMARY OF THE INVENTION

Accordingly, the object of the present invention was to develop anionically stabilized dispersions of nanoparticle zinc oxide that are insensitive to added electrolytes and anionic dispersion constituents, without having the disadvantages of the aforedescribed processes.

This object of the invention was achieved by the zinc oxide dispersions according to the present invention that are described in more detail hereinafter.

### DETAILED DESCRIPTION OF THE INVENTION

The present invention provides for anionically stabilized, aqueous dispersions of nanoparticle zinc oxide having a mean primary particle diameter of ≦30 nm, preferably ≦15 nm, and a mean agglomerate size of ≦100 nm, preferably ≦50 nm, the surface of the zinc oxide particles at pH values of ≧7, preferably ≧8, having a negative charge, and the content of nanoparticle zinc oxide in the dispersion being 0.01 to 30 wt. %, preferably 0.05 to 20 wt. %, and more preferably 0.05 to 15 wt. %.

A negative charge is understood to mean a negative Zeta potential that has been measured in a conventional manner by microelectrophoresis using a Malerva Zetasizer.

According to the present invention, the negative charge measured at pH values of ≧7, expressed as a negative Zeta potential of <−30 mV, is preferably <40 mV.

The present invention also provides a process for the production of the anionically stabilized, aqueous zinc dispersions having the aforementioned mean primary particle diameters and mean agglomerate sizes, which is characterized in that an aqueous zinc oxide dispersion that contains zinc oxide particles having the aforementioned primary particle diameters and agglomerate sizes is treated with alkali silicate solutions, the content of nanoparticle zinc oxide in the dispersion being 0.01 to 30 wt. %, preferably 0.05 to 20 wt. %, and more preferably 0.05 to 15 wt. %.

By means of this treatment according to the present invention of the corresponding zinc oxide dispersions with alkali silicate solution, the anionically stabilized zinc oxide dispersions according to the present invention are then obtained if—as previously mentioned—the surface of the zinc oxide particles at pH values of ≧7 is negatively charged.

The process according to the present invention is preferably carried out by dispersing a suitable zinc oxide at pH values below its isoelectric point in water and adding alkali silicate solutions (hereinafter termed water glass) or mixtures of water glass with bases or mixtures of water glass with bases and stabilizers, in such a way that the zinc oxide undergoes an anionic charge reversal without flocculating. The addition preferably takes place under vigorous stirring, more preferably using a rotor-stator system, such as, for example, an Ultraturrax, a nozzle jet disperser or a similar apparatus, or also under the action of ultrasound.

Alkali silicates that may be used are, in particular, sodium and potassium water glass.

It is preferred to use nanoparticle zinc oxides that can easily be dispersed in water in a primary particle-disperse or almost primary particle-disperse manner. It is preferred to use such zinc oxides having mean primary particle sizes of ≦30 nm, preferably ≦15 nm. It is most preferred to use zinc oxide gels or suspensions obtained by basic hydrolysis of zinc compound in alcohols or alcohol-water mixtures, such as described in DE 199 07 704 A1.

The zinc oxide is added to water and dispersed by stirring. The dispersion that is formed, which is translucent to milky depending on the concentration and dispersion state, contains ca. 0.01 to 30 wt. % of ZnO, preferably 0.05 to 20 wt. % and more preferably 0.05 to 15 wt. % of ZnO. When using a methanol-containing ZnO suspension as ZnO source, the methanol is preferably removed from the aqueous suspension, for example by distillation. In order to improve the stability of the dispersion, suitable additives may be added, preferably 6-aminohexanoic acid or comparable substances that prevent gelling.

The mean agglomerate size of the dispersed zinc oxide particles is ca. ≦100 nm, preferably ≦50 nm. The particle sizes of the primary particles are determined by TEM scanning (transmission electron microscopy scanning) and the agglomerate sizes are determined by ultracentrifuge measurements.

The temperature of the dispersion process may be between the freezing point of the dispersion agent and its boiling point, preferably between ca. 10° and 80° C.

The charge reversal may be carried out with aqueous alkali silicate solutions, sodium water glass being preferred. In this connection, the silicate solution may be used diluted or also undiluted. The concentration of the alkali silicates in the aqueous solution is ca. 0.1 to 10 wt. %, preferably 0.5 to 2 wt. %, referred to commercially available 35% silicate solution. The amount of alkali silicate solution used for the charge reversal or treatment of the aqueous ZnO dispersion is calculated so that the aforementioned negative charge is formed on the surface of the ZnO particles.

In a preferred embodiment bases, preferably alkali hydroxides, are added to the alkali silicate solution. It is more preferred to use aqueous sodium hydroxide. The concentration of the bases in the aqueous solution is normally 1 to 10 wt. %, preferably 4 to 6 wt. %, referred to 1N NaOH.

In a further preferred embodiment, a stabilizer in addition to the base is added to the silicate solution. It is preferred to use polyacrylic acid salts, such as, for example, sodium polyacrylate salt having a mean molecular weight of 5100. The amount of added stabilizer in the aqueous solution is ca. 0.01 to 1 wt. %, preferably 0.05 to 0.2 wt. %, referred to the salt.

The charge reversal temperature may lie between the freezing point of the dispersion agent and its boiling point, preferably ca. 10° to 80° C., more preferably 20° C. to 60° C.

The charge reversal is preferably carried out in a reactor equipped with an Ultraturrax. In this connection, the conditions both as regards the zinc oxide concentration and as regards the mixing conditions and the shear forces are chosen so that the zinc oxide does not flocculate during the charge reversal.

The zinc oxide dispersion that is thus obtained, may be adjusted to the desired pH value by adding acids such as sulfuric acid, bases such as sodium hydroxide, buffering substances such as sodium phosphates, or by using ion exchangers, such as for example Lewatiten®, or by diafiltration. The use of ion exchangers is preferred.

If necessary, the zinc oxide dispersion that is thus obtained, may be concentrated for example, by distillation, by centrifugation or by membrane filtration.

In a further embodiment, the aqueous zinc oxide dispersion is first of all stabilized by adding suitable stabilizers and is then reacted with alkali silicate solutions.

Alternatively, the charge reversal can also be carried out by first of all flocculating the ZnO dispersion and then re-dispersing the latter.

In this case, the zinc oxide that is used is added to water and dispersed by stirring. The dispersion that is obtained, which is translucent to milky depending on the concentration and dispersion state, contains ca. 0.01 to 30 wt. % ZnO, preferably 0.05 to 20 wt. %, more preferably 0.05 to 15 wt. % ZnO.

The charge reversal is carried out by combining the aqueous zinc oxide dispersion and the aqueous silicate solution. In this connection, the concentration and the mixing conditions are chosen so that the zinc oxide flocculates.

The flocculation temperature may be between the freezing point of the dispersion agent and its boiling point, preferably ca. 10° to 100° C., more preferably between 20° C. and 70° C.

After the flocculation, the supernatant may be separated from the flocculated material by filtration, sedimentation or centrifugation, immediately or after relatively prolonged stirring, which may be carried out in the temperature range specified above.

The separated flocculate may be redispersed by adding water, but also by adding water/stabilizer mixtures, in which connection water/polyelectrolyte mixtures are preferred and water/sodium acrylate mixtures are preferred. This redispersion may be effected by stirring, optionally at elevated temperature, preferably under high shear forces, more preferably by using rotor-stator systems and/or under the action of ultrasound and/or a nozzle jet disperser.

The redispersed fraction is separated from the non-dispersed residue by filtration, sedimentation, centrifugation or a suitable separation process. The procedures for redispersion and separation may be repeated several times in order to obtain a better yield of dispersed material.

The zinc oxide dispersion thus obtained may in turn, be adjusted to the desired pH value by addition of acids or bases or by using ion exchangers.

If necessary, the zinc oxide dispersion that is thus obtained may be concentrated, for example by distillation, centrifugation or by membrane filtration.

In a further embodiment of the invention, an aqueous zinc oxide dispersion is first of all, destabilized by altering the pH value, preferably by the addition of aqueous alkali hydroxides, is next separated from the supernatant after settling, and is then taken up again with water or with water/stabilizer mixtures, in which connection mixtures of water and sodium salts of polyacrylic acids are preferred. This may be effected by stirring, optionally at elevated temperature, preferably under high shear forces, more preferably by the use of rotor-stator systems and/or under the action of ultrasound and/or a nozzle jet disperser.

The dispersions that are thereby obtained may be converted into stable dispersions by addition of aqueous alkali silicate solutions, without this resulting in flocculation as described above.

The present invention also provides for the use of the anionically stabilized dispersions of nanoparticle zinc oxide according to the present invention as a vulcanization co-activator in the vulcanization of latex molded articles.

The anionically stabilized dispersions of nanoparticle zinc oxide according to the present invention may—as previously mentioned—be used as vulcanization co-activators in the production of lattices based on all types of natural and synthetic rubbers.

Suitable rubbers that may be used for the production of lattices include, in addition to a very wide range of natural latex rubbers, also synthetic rubbers such as:

polyisoprenes,

acrylonitrile/butadiene copolymers,

carboxylated acrylonitrile/butadiene copolymers,

carboxylated acrylonitrile/butadiene copolymers, also with self-crosslinking groups,

styrene/butadiene copolymers,

carboxylated styrene/butadiene copolymers,

carboxylated styrene/butadiene copolymers, also with self-crosslinking groups,

acrylonitrile/butadiene/styrene copolymers,

carboxylated acrylonitrile/butadiene/styrene copolymers,

carboxylated acrylonitrile/butadiene/styrene copolymers, also with self-crosslinking groups, as well as

chlorobutadiene lattices and carboxylated chlorobutadiene lattices.

However, natural latex, carboxylated acrylonitrile/butadiene copolymers and chlorobutadiene lattices as well as carboxylated chlorobutadiene lattices are preferred.

In the vulcanization of the various rubber lattices, the zinc oxide dispersion according to the present invention is added during the vulcanization in amounts of about 2.0 to 0.01, preferably 0.5 to 0.05, referred to 100 parts by weight of a latex mixture (dry/dry).

### EXAMPLES

The optical determinations of the colloidal ZnO content were, unless otherwise specified, carried out with a Shimadzu UVVIS spectrometer using 1 cm quartz cells, ε₃₀₂=12.4 L/(g×cm) was chosen as extinction coefficient.

The quotient of the extinction measured at 350 nm and 400 nm in a quartz cell (1 cm) with a UVVIS spectrometer (see above) was adopted as quality characteristic Q. In this connection the higher the value of Q, the smaller the scattered fraction contained in the spectrum and the better dispersed are the zinc oxide particles contained in the dispersion.

The centrifugation operations were carried out, unless otherwise specified, in a Heraeus laboratory centrifuge (Cryofuge 6000i) with a 22.9 cm rotor (radius for the centre of the beaker).

### Example 1

Component A:

A solution of 10 g of 6-aminohexanoic acid in 1000 g of water is added to 489.4 g of a 33.65% methanolic ZnO nanoparticle suspension obtained according to DE 199 07 704 A1, made up to 4500 g with further water, and dispersed by stirring (30 minutes). The contained methanol was removed from the dispersion by distillation and the dispersion was adjusted to 3% ZnO by addition of water (5010 g, pH=7.2, quality characteristic Q=73).

Component B:

6.8 g of sodium water glass from Aldrich were mixed with 34 g of 1N NaOH and 1.26 g of sodium polyacrylate (Fluka 5100 (mean molecular weight)) and made up to 835 g with water.

1670 g of the component A and the whole amount of component B were added to separate storage vessels and fed via hose lines at a rate of 50 ml/min. (A) and 25 ml/ min. (B) to a mixing chamber containing 300 ml of water, and the whole was thoroughly mixed using an Ultraturrax (IKA, T25Basic, Type S25N-18G dispersing device) at 24000 r.p.m. The product formed from the mixing of A and B was continuously discharged from the mixing chamber at a rate of 75 ml/min. into a receiver. 2042.3 g of a 2% ZnO dispersion (Q=43) were obtained after separation of 396.2 g of first runnings and 266.9 g of tailings. 14.6 g of a weakly acidic ion exchanger resin (drained weight; Lewatit® CNP80WS, Bayer AG) were added to this dispersion and stirred for 25 minutes at 60° C. After separating the ion exchanger resin the pH value at room temperature was 8.3 A further 2.9 g of sodium polyacrylate dissolved in 60 g of water were added to this dispersion (2054 g). 931.8 g of this dispersion were concentrated by evaporation in a rotary evaporator to a final concentration of 11% ZnO (Q=33).

The ultracentrifuge measurement of the dispersion thus obtained gave a mean agglomerate size of 33 nm (d₅₀ value of the mass distribution).

### Example 2

### Comparison Without Water Glass

1650 g of a 3% aqueous dispersion (component A) produced as described in Example 1 and 825 g of a mixture consisting of 33.8 g of 1 N NaOH and 3.25 g of Dispex N 40 and water (component B) were added to separate storage vessels and fed via hose lines at a rate of 50 ml/min. (A) and 25 nm/min. (B) to a mixing chamber containing 300 ml of water and mixed therein with an Ultraturrax (IKA, T25 Basic, Type S25N-18G dispersing device) at 24000 r.p.m. The product formed from the mixing of A and B was continuously discharged from the mixing chamber at a rate of 75 ml/min. into a receiver. 2039.1 g of a 2% ZnO dispersion (Q=17) were obtained after separating 395.4 g of first runnings and 248.1 g of tailings. 15.5 g of a weakly acidic ion exchanger resin (drained weight; Lewatite® CNP80WS, Bayer AG) were added to this dispersion and stirred for 15 minutes at 60° C. After separating the ion exchanger resin the pH value at room temperature was 8.3. After a short standing time it was found that the dispersion had demixed.

### Example 3

### Production of the Anionically Stabilized Dispersion by the Flocking Process According to the Present Invention

200 g of a 31.2% methanolic zinc oxide dispersion obtained as described in DE 199 07 704 A1 and washed salt-free by countercurrent ultrafiltration were made up to 833 g with water in a beaker and dispersed by stirring with a blade stirrer (30 min.). The dispersion was then concentrated to 600 g in a rotary evaporator at 50° C. bath temperature.

A mixture of 10.3 g of sodium water glass, 20.8 g of 1 N sodium hydroxide and 278 g of water was added to a 1 L capacity beaker and the ZnO dispersion was added through a dropping funnel over 4 minutes while stirring vigorously with an Ultraturrax (IKA, T25 Basic, at 18000 r.p.m.). After the end of the addition, the mixture was stirred for a further minute with the Ultraturrax, transferred to a flask, and stirred at 60° C. for 20 minutes with a blade stirrer. After cooling in an ice bath, the mixture was centrifuged for 60 minutes at 4240 rpms. The supernatants were decanted and the residues were taken up in 300 g of water and stirred for 30 minutes. The solutions were centrifuged again (4240 rpms, 60 minutes) and the supernatants were decanted. The residues were combined, 500 g of a 0.1% sodium polyacrylate solution were added (Fluka, sodium polyacrylate, 5′100) and dispersed for 7 minutes in the Ultraturrax (Ika Werke, T25 Basic) at 18000 rpms. The non-dispersed fraction was separated by centrifugation (4240 rpms., 40 min.). The dispersion procedure was repeated a further two times and the residues were collected (1607 g, 3.17 ZnO, Q=33). The anionically stabilized ZnO dispersion obtained in this way was adjusted to pH=8.5 with a weakly acidic ion exchanger (Lewatit® CNP 80 WS), 3.4 g of sodium polyacrylate were added (Fluka, sodium polyacrylate, 5′100), and the mixture was concentrated to 475 g in a rotary evaporator at 60° C. bath temperature. The mixture was then filtered first through a 1 μm membrane filter and then through a 0.2 μm membrane filter. The dispersion obtained had a pH value of 9, a ZnO content of 10.14% and a Q value of 32. An elementary analysis showed a Zn content of 8.5%, corresponding to 10.6% of zinc oxide.

Ultracentrifuge measurements gave a mean agglomerate size of 28 nm (d₅₀ value of the mass distribution).

### Example 4

### Use of the Dispersion Obtained From Example 3 for the Production of Latex Molded Articles

167 g of a type HA natural latex are mixed with 5.0 parts by weight of a 10% potassium hydroxide solution and with 1.25 parts by weight of a stabilizer, preferably a 20% potassium laurate solution, at room temperature while stirring, and then stabilized. 7.8 parts by weight of the ground vulcanization paste with a concentration of 50% are then added. This vulcanization paste contains 1.5 parts by weight of colloidal sulfur, 0.6 part by weight of a zinc dithiocarbamate accelerator (ZDEC), 0.3 part by weight of a zinc mercaptobenzothiazole accelerator (ZMBT), and 1.0 part by weight of a phenol-based anti-aging agent and a 5% aqueous solution of a dispersion agent containing a sodium salt of a condensation product of naphthalenesulfonic acid and formaldehyde. This mixture is then adjusted to a solids concentration of 45% by the addition of water.

The maturation process is then carried out over 16 hours at a temperature of 30° C. 0.1 part by weight of a nano-scale zinc oxide as described in Example 3, with an adjusted concentration of 10.1% is then added, while stirring, shortly before the maturation in order to improve the distribution.

This matured compound is filtered through a 100 μfilter. This is followed by the dipping process, which is carried out on specially prepared glass plates. These glass plates are dipped beforehand in an aqueous coagulant solution containing 15% calcium nitrate solution with an addition of 10% of a finely particulate chalk, and dried. The thus prepared glass plates are dipped in the mixture described hereinbefore for ca. 20 secs. in order to obtain a film coating of ca. 0.20 mm.

The films produced in this way are then dried at 80° C. in hot air (30 minutes), followed directly by vulcanization at 120° C. for 5 minutes.

The films produced in this way are conditioned for 24 hours under standard climatic conditions and then undergo, unaged, a strength test in which the modulus, strength and elongation at break are measured.

The results show, with the significantly lower dosage, comparable strength values (27.9 MPa/5 minutes' vulcanization) to the comparison test with 1.0 part by weight of zinc oxide white seal (29.1 MPa/5 minutes) or with 0.5 part by weight of a high surface area zinc oxide (32.4 MPa/5 minutes).

The modulus at 300% elongation is significantly lower than in the comparison samples using zinc oxide white seal (WS) not according to the present invention, or a zinc oxide with a higher surface area. This effect leads to an improved wearability.

The elongation at break (864%/5 minutes) likewise exhibits higher values than the comparison test with 1.0 part by weight of zinc oxide white seal (790%/5 minutes) or 0.5 part by weight of a high surface area zinc oxide (843%/5 minutes).

The evaluation after aging shows significant improvements in the stability after 8, 16 and 24 hours' storage in a hot atmosphere at 100° C. The degradation of the rubber proceeds more slowly than in the case of the zinc oxides not according to the present invention. The reduction in strength is in this case only 22.6%. Compared to conventionally used zinc oxide the reduction in strength is 37.2%.

### Example 5

167 g of a type HA natural latex are mixed with 5.0 parts by weight of a 10% potassium hydroxide solution and with 1.25 parts by weight of a stabilizer, preferably a 20% potassium laurate solution, at room temperature while stirring, and stabilized. 7.8 parts by weight of the ground vulcanization paste in a concentration of 50% are then added. This vulcanization paste consists of 1.5 parts by weight of colloidal sulfur, 0.6 part by weight of a zinc dithiocarbamate accelerator (ZDEC), 0.3 part by weight of a zinc mercaptobenzothiazole accelerator (ZMBT), and 1.0 part by weight of a phenol-based anti-ageing agent, and a 5% aqueous solution of a dispersion agent consisting of a sodium salt of a condensation product of naphthalenesulfonic acid and formaldehyde.

This mixture is then adjusted to a solids concentration of 45% by the addition of water.

The maturation process then takes place over 16 hours at a temperature of 30° C. 0.05 part by weight of a nano-scale zinc oxide as described in Example 3, with an adjusted concentration of 10.1% is then added, while stirring, shortly before maturation, in order to achieve a better distribution.

This matured compound is filtered through a 100 μ filter. This is then followed by the dipping process, which is carried out on specially prepared glass plates. These glass plates are dipped beforehand in an aqueous coagulant solution consisting of 15% calcium nitrate solution with an addition of 10% of a finely particulate chalk, and dried. The glass plates prepared in this way are dipped in the previously described mixture for ca. 20 secs. in order to obtain a film coating of ca. 0.20 mm.

The thus produced films are then dried at 80° C. in hot air (duration 30 minutes), followed directly by the vulcanization at 120° C. for 5 minutes.

After a conditioning phase lasting 24 hours under standard climatic conditions, the films produced as described above are subjected unaged to a strength test, in which the modulus, strength and elongation at break are measured.

The results show in the even further reduced dosage comparable strength values (29.6 MPa/5 minutes' vulcanization) to the comparison test with 1.0 part by weight of zinc oxide white seal (29.1 MPa/5 minutes) or with 0.5 part by weight of a high surface area zinc oxide (32.4 MPa/5 minutes).

In this connection, the modulus at 300% and 700% elongation is substantially lower than in the comparison samples using zinc oxide white seal (WS) (not according to the present invention), or a zinc oxide having a higher surface area. This effect leads to an improved wearability.

The elongation at break (925%/5 minutes) likewise exhibits higher values than the comparison test with 1.0 part by weight of zinc oxide white seal (790%/5 minutes) or with 0.5 part by weight of a high surface area zinc oxide (843%/5 minutes).

The evaluation after aging shows significant improvements in the stability after 8, 16 and 24 hours' storage in hot air at 100° C. The degradation of the rubber proceeds more slowly than in the zinc oxides not according to the present invention. The reduction in strength is in this case only 19.6%. Compared to conventionally used zinc oxide the reduction in strength is 37.2%.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Anionically stabilized aqueous dispersions of nanoparticle zinc oxide comprising nanoparticle zinc oxides having a mean primary particle diameter of ≦30 nm and a mean agglomerate size of ≦100 nm, wherein the surface of the zinc oxide particles at pH values of ≧7 has a negative charge and the content of nanoparticle zinc oxide in the dispersion is 0.01 to 30 wt. %.

2. Anionically stabilized aqueous dispersions of nanoparticle zinc oxide according to claim 1, wherein the surface of the zinc oxide particles at pH values of ≧7 has a negative charge, expressed as negative Zeta potential, of <−30 mV.

3. A process for the production of anionically stabilized aqueous dispersions of nanoparticle zinc oxide comprising the step of treating an aqueous zinc oxide dispersion that contains zinc oxide particles having a mean primary particle diameter of ≦30 nm and a mean agglomerate size of ≦100 nm with alkali silicate solutions, the content of zinc oxide in the dispersion being 0.01 to 30 wt. %.

4. Vulcanization activators for the vulcanization of latex molded articles comprising anionically stabilized dispersion of nanoparticle zinc oxides which comprise nanoparticle zinc oxides having a mean primary particle diameter of ≦30 nm and a mean agglomerate size of ≦100 nm, wherein the surface of the zinc oxide particles at pH values of ≧7 has a negative charge and the content of nanoparticle zinc oxide in the dispersion is 0.01 to 30 wt. %.
